(19) United States
(12) Patent Application Publication
(10) Pub. No.: US 2002/0097865 A1
(43) Pub. Date: Jul. 25, 2002

(54) Mask-A-Tel

(76) Inventor: James A. Del Giudice, Huntington, NY (US)

Correspondence Address: James a. Del Giudice, 85 Summit Drive, Huntington, NY, 11743, US

(21) Appl. No.: 09/764,234

(22) Filed: Jan. 19, 2001

(51) Int. Cl. H04M 9/00

(52) U.S. Cl. 379/431

(57) ABSTRACT

A cover or mask to prevent the spread of germs from a telephone mouthpiece. The mask or cover is made of a porous nylon stretchable material. Antibacterial, such as lysol or similiar is sprayed onto the mask. the mask can be used wherever telephones are used by more then one person, such as a payphone or an office.

### BRIEF DESCRIPTION OF FIGURES

FIG. 1 Shows stretch material cut to proper size to fit tight over a telephone mouth piece

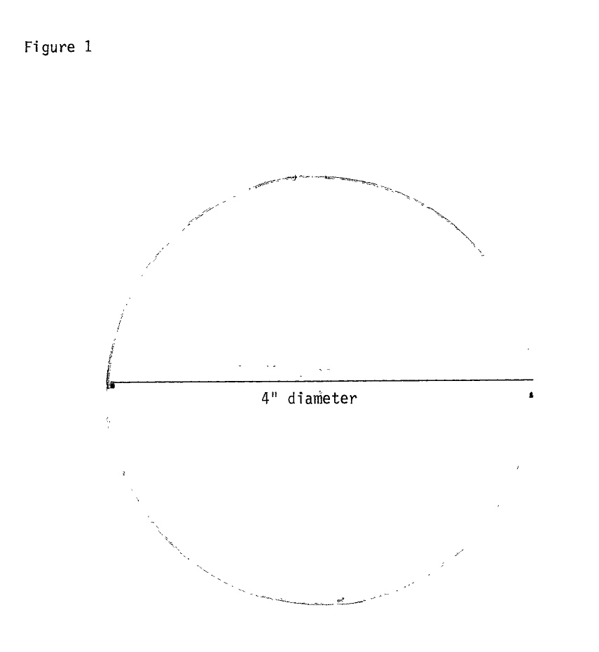

FIG. 2 Shows the elastic cut to the correct size to be sewn on to FIG. 1

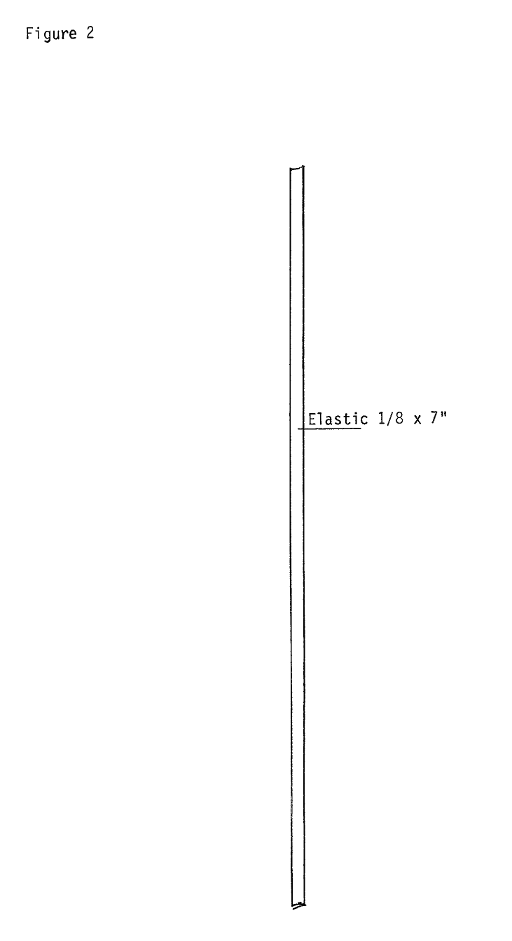

FIG. 3 Shows the complete Mask-A-Tel which fits tightly on to a telephone mouth piece

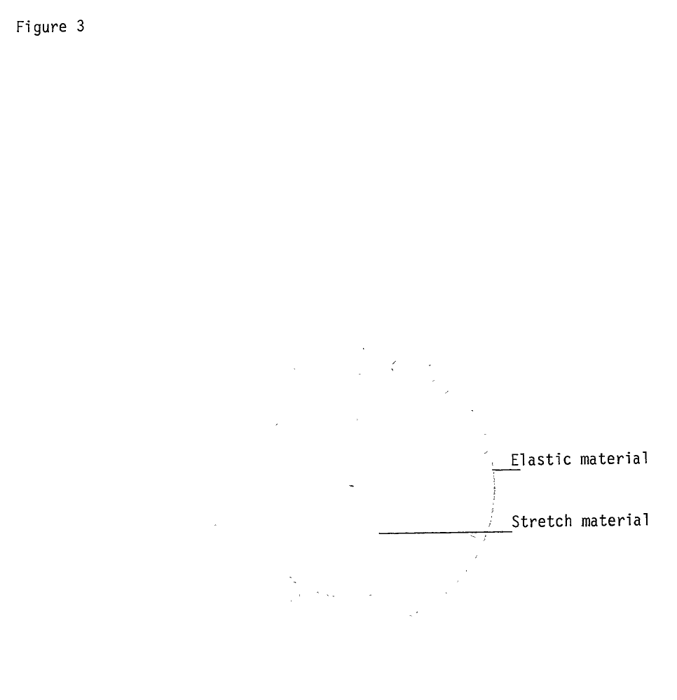

### SUMMARY OF INVENTION

This invention provides a method of producing masks or covers that prevent the spread of germs from the mouth piece of telephones used by more then one person. Masks or covers are made by: 1) Cutting a seven inchpiece of elastic 2) Cutting a 4 inch diameter piece of strectable material (such as nylon) 3) Sewing on the seven inch piece of elastic to the four inch diameter material so that it is tight enough to fit securely onto a mouth piece of a telephone The material is then treated with an anti-bacteria to further enhance the objective. The entire unit is hermetically sealed until ready fo use.

1) I claim a method of making a mask or cover to place over a mouthpiece of a telephone to prevent the spread of germs

2) Using a round stretch cover or mask with antibacteria spray to place over the mouth piece of any telephone with more then one person using it

3) Using a round stretch cover porous enough to speak through on a telephone mouth piece

4) Using a round stretch material non-porous enough to stop the spread of germs on a telephone mouth piece

5) Using a round stretch cover or mask porous enough so the person listening can hear the other person talk on the other end of the telephone

6) Using a round paper cover with a stretch material on the circumference of the cover with anti-bacteria spray to place over a telephone mouthpiece
